(19) United States
(12) Patent Application Publication
(10) Pub. No.: US 2015/0306758 A1
(43) Pub. Date: Oct. 29, 2015

(54) POWER TOOL AND ACCESSORY DEVICE THEREOF

(71) Applicant: CHERVON INTELLECTUAL PROPERTY LIMITED, Road Town (VG)

(72) Inventors: Cuihua Chen, Nanjing (CN); Shubin Tong, Nanjing (CN)

(21) Appl. No.: 14/688,319

(22) Filed: Apr. 16, 2015

(30) Foreign Application Priority Data
Apr. 24, 2014 (CN) 201420204399.0

(51) Int. Cl. B25F 5/02; B25G 3/00

(52) U.S. Cl. CPC B25F 5/02; B25G 3/00

(57) ABSTRACT

An accessory device for a power tool includes a first moving member, a second moving member, a functioning member associated with at least one of the first moving member and the second moving member, and a connecting assembly for connecting the first moving member and the second moving member. The first moving member is provided with a first installing member and the second moving member is provided with a second installing member. The first installing member and the second installing member are located in an installation state when the first moving member and the second moving member are moved towards each other to a preset position. The connecting assembly forces the first moving member and the second moving member to move simultaneously in a straight direction to enable the first installing member and the second installing member to be moved into or out of the installation state.

### RELATED APPLICATION INFORMATION

This application claims the benefit of CN 201420204399.0, filed on Apr. 24, 2014, the disclosure of which is incorporated herein by reference in their entirety.

### FIELD OF THE DISCLOSURE

The present disclosure relates to an accessory device, particularly for use with a power tool.

### BACKGROUND OF THE DISCLOSURE

Power tools generally include a tool body and an accessory device for the tool body. But, in the power tools, there is a contradiction which cannot be resolved between the tool body and the accessory device. It is desired that the tool body and the accessory device may be disassembled easily, but the connection between the tool body and the accessory device which may be disassembled easily is generally insecure. Instead, when it is desired that the tool body and the accessory device are tightly connected, there is a problem that the tool body and the accessory device cannot be easily disassembled.

### SUMMARY

The disclosure describes an accessory device for a power tool, including: a first moving member; a second moving member; a functioning member associated with at least one of the first moving member and the second moving member; and a connecting assembly for connecting the first moving member and the second moving member; wherein the first moving member is provided with a first installing member and the second moving member is provided with a second installing member, wherein the first installing member and the second installing member are located in an installation state when the first moving member and the second moving member are moved towards each other to a preset position; and wherein the connecting assembly forces the first moving member and the second moving member to move simultaneously in a straight direction so as to enable the first installing member and the second installing member to be moved into or out of the installation state.

Furthermore, the accessory device may include a guide assembly for guiding a relative movement between the first moving member and the second moving member.

Furthermore, the guide assembly may include a guide pin with two ends respectively and slidably arranged in the first moving member and the second moving member.

Furthermore, the accessory device may include a driving assembly for driving the first moving member and the second moving member to enable the first installing member and the second installing member to be located in the installation state.

Furthermore, the driving assembly may include a biasing member for acting on the first moving member and the second moving member to force the first installing member and the second installing member to be located in a preset state.

Furthermore, the connecting assembly may include a threaded rod connected to the first moving member and the second moving member respectively by two sections of external threads with opposite revolving directions.

Furthermore, the accessory device may include a guide assembly for guiding a relative movement between the first moving member and the second moving member and a driving assembly for driving the first moving member and the second moving member to force the first installing member and the second installing member to be located in the installation state.

Furthermore, the guide assembly may include a guide pin with two ends respectively and slidably arranged in the first moving member and the second moving member, the first moving member may be provided with a guide hole, the second moving member may be provided with a guide groove, the two ends of the guide pin may be arranged in the guide hole and the guide groove respectively, the connecting assembly may include a threaded rod connected to the first moving member and the second moving member respectively by two sections of external threads with opposite revolving directions, the first moving member may be provided with a first threaded hole, the second moving member may be provided with a second threaded hole, the first threaded hole and the second threaded hole may have internal threads with different revolving directions respectively, the threaded rod may pass through the second threaded hole and extend into the first threaded hole, and the two sections of external threads of the threaded rod may cooperate with the internal threads in the first threaded hole and the second threaded hole respectively.

Furthermore, the driving assembly may include a biasing member for acting on the first moving member and the second moving member to force the first installing member and the second installing member to be located in a preset state, the biasing member may be a spiral spring, one side of the second moving member distal from the first moving member may be provided with an opening groove which is communicated with the second threaded hole, the threaded rod may protrude out from the opening groove, the spiral spring may be sleeved on a portion of the threaded rod protruding out from the opening groove, one end of the spiral spring may abut against a groove bottom of the opening groove and the other end may abut against a stopping structure provided by the threaded rod.

The disclosure also describes a power tool, including: a main body; and an accessory device for the main body; wherein the accessory device comprises a first moving member, a second moving member, a functioning member associated with at least one of the first moving member and the second moving member and a connecting assembly for connecting the first moving member and the second moving member; wherein the first moving member is provided with a first installing member and the second moving member is provided with a second installing member; wherein the first installing member and the second installing member are located in an installation state when the first moving member and the second moving member are moved towards each other to a preset position; wherein the connecting assembly forces the first moving member and the second moving member to move simultaneously in a straight direction so as to enable the first installing member and the second installing member to be moved into or out of the installation state; and wherein the main body is provided with an installing structure for cooperating with the first installing member and the second installing member.

Furthermore, the main body may include a housing, the installing structure is a slot formed in the housing, and the first installing member and the second installing member are jaws capable of being embedded into the slot.

Furthermore, the connecting assembly may include a threaded rod connected to the first moving member and the second moving member respectively by two sections of external threads with opposite revolving directions.

The disclosure also describes a handle for a power tool, including: a first moving member; a second moving member; a gripping member associated with at least one of the first moving member and the second moving member; and a connecting assembly for connecting the first moving member and the second moving member; wherein the first moving member is provided with a first installing member and the second moving member is provided with a second installing member; wherein the first installing member and the second installing member are located in an installation state when the first moving member and the second moving member are moved towards each other to a preset position; and wherein the connecting assembly forces the first moving member and the second moving member to move simultaneously in a straight direction so as to enable the first installing member and the second installing member to be moved into or out of the installation state.

Furthermore, the handle may include a guide assembly for guiding the relative movement between the first moving member and the second moving member and a driving assembly for driving the first moving member and the second moving member to force the first installing member and the second installing member to be located in the installation state.

Furthermore, the connecting assembly may include a threaded rod connected to the first moving member and the second moving member respectively by two sections of external threads with opposite revolving directions.

Furthermore, the guide assembly may include a guide pin with two ends respectively and slidably arranged in the first moving member and the second moving member, the first moving member may be provided with a guide hole, the second moving member may be provided with a guide groove, the two ends of the guide pin may be arranged in the guide hole and the guide groove respectively, the connecting assembly may include a threaded rod connected to the first moving member and the second moving member respectively by two sections of external threads with opposite revolving directions, the first moving member may be provided with a first threaded hole, the second moving member may be provided with a second threaded hole, the first threaded hole and the second threaded hole may have internal threads with different revolving directions respectively, the threaded rod may pass through the second threaded hole and extend into the first threaded hole, the two sections of external threads with opposite revolving directions of the threaded rod may cooperate with the internal threads in the first threaded hole and the second threaded hole respectively, the driving assembly may include a biasing member for acting on the first moving member and the second moving member to force the first installing member and the second installing member to be located in a preset state, the biasing member may be a spiral spring, one side of the second moving member distal from the first moving member may be provided with an opening groove which is communicated with the second threaded hole, the threaded rod may protrude out from the opening groove, the spiral spring may be sleeved on a portion of the threaded rod protruding out from the opening groove, one end of the spiral spring may abut against a groove bottom of the opening groove and the other end may abut against a stopping structure formed or provided by the threaded rod.

The statements in this section merely provide background information related to the present disclosure and may not constitute prior art.

### BRIEF DESCRIPTION OF THE DRAWINGS

FIG. 1 is a structure schematic view of an exemplary embodiment of an accessory device of the present disclosure.

FIG. 2 is a partial structure schematic view of the accessory device of FIG. 1.

FIG. 3 is structure schematic view of a positioning device formed by the accessory device of the present disclosure.

FIG. 4 is a structure schematic view of a handle formed by the accessory device of the present disclosure.

FIG. 5 is a structure schematic view of an exemplary power tool comprising the accessory device of the present disclosure.

FIG. 6 is a structure schematic view of a main body of the power tool of FIG. 5.

The drawings described herein are for illustrative purposes only of exemplary embodiments and not all possible implementations, and are not intended to limit the scope of the present disclosure. Corresponding reference numerals indicate corresponding parts throughout the several views of the drawings.

### DETAILED DESCRIPTION

The following description of preferred embodiments is merely exemplary in nature and is in no way intended to limit the scope of the claimed invention, its application, or uses.

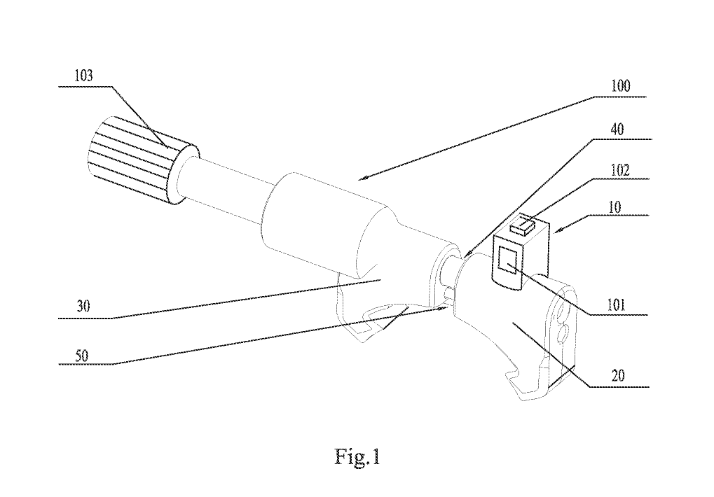

Referring to FIG. 1, an accessory device 100 of the present disclosure comprises a functioning member 10, a first moving member 20, a second moving member 30, a connecting assembly 40, a guide assembly 50 and a driving assembly. The functioning member 10 is associated with at least one of the first moving member 20 and the second moving member 30.

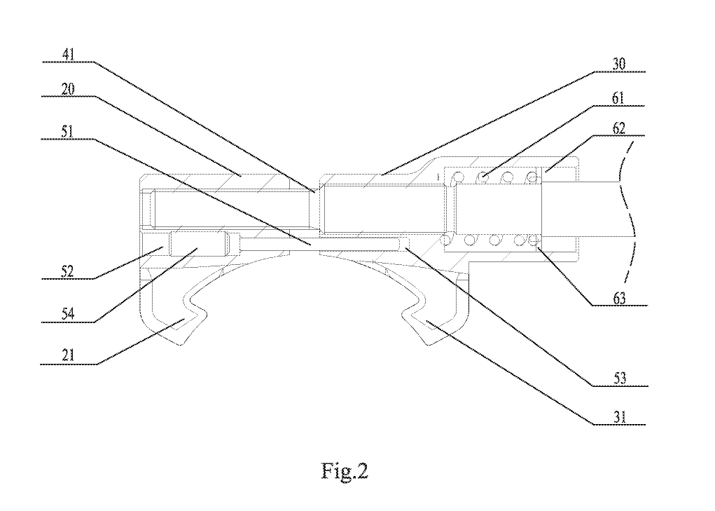

Referring to FIGS. 1 and 2, the first moving member 20 and the second moving member 30 may move towards each other relative to the connecting assembly 40. The first moving member 20 is provided with a first installing member 21 and the second moving member 30 is provided with a second installing member 31. The first installing member 21 and the second installing member 31 may be located in an installation state when the first moving member 20 and the second moving member 30 are moved towards each other to a preset position.

The connecting assembly 40 connects the first moving member 20 and the second moving member 30. The connecting assembly 40 forces the first moving member 20 and the second moving member 30 to move simultaneously in a straight direction. When the connecting assembly 40 forces the first moving member 20 and the second moving member 30 to be moved towards each other in the straight direction, the first installing member 21 and the second installing member 31 reach the installation state, and when the connecting assembly 40 forces the first moving member 20 and the second moving member 30 to be moved away from each other in the straight direction, the first installing member 21 and the second installing member 31 are out of the installation state, thereby achieving one-hand operation of the accessory device 100.

The connecting assembly 40 is a threaded rod 41 connected to the first moving member 20 and the second moving member 30 respectively by two sections of external threads with opposite revolving directions. Specifically, the first moving member 20 is provided with a first threaded hole, and the second moving member 30 is provided with a second threaded hole. The first threaded hole and the second threaded hole have internal threads with different revolving directions respectively. The threaded rod 41 passes through the second threaded hole and extends into the first threaded hole, thereby connecting the first moving member 20 and the second moving member 30. The two sections of external threads cooperate with the inner threads in the second threaded hole and the first threaded hole respectively. Thus, when the threaded rod 41 is rotated, the first moving member 20 and the second moving member 30 may be forced to move in the straight direction, and the moving directions of the first moving member 20 and the second moving member 30 relative to the functioning member 10 are opposite, thereby the first moving member 20 and the second moving member 30 can simultaneously be moved towards or away from each other so as to enable the first installing member 21 and the second installing member 31 to be in or out of the installation state.

The guide assembly 50 is used to guide the relative movement of the first moving member 20 and the second moving member 30. Specifically, the guide assembly 50 may be a guide pin 51 with two ends respectively and slidably arranged in the first moving member 20 and the second moving member 30. The first moving member 20 is provided with a guide hole 52 for receiving one end of the guide pin 51, and the second moving member 30 is provided with a guide groove 53 for receiving the other end of the guide pin 51. The position of the guide hole 52 in the first moving member 20 corresponds to the position of the guide groove 53 in the second moving member 30. Thus, when the first moving member 20 and the second moving member 30 move towards each other, the first moving member 20 and the second moving member 30 will not move in other directions besides the direction of the relative movement, thereby preventing the first installing member 21 and the second installing member 31 from rotating relative to each other. The end of the guide hole 52 away from the guide pin 51 is provided with a sealing member 54 for preventing the guide pin 51 from disengaging from the first moving member 20 or the second moving member 30. The sealing member 54 may be a screw. The guide assembly 50 may also be other assemblies for achieving a guiding function. For example, the side of the first moving member 20 facing the second moving member 30 can be provided with a convex column, and the second moving member 30 is correspondingly provided with a groove for receiving the convex column.

The driving assembly is used to force the first moving member 20 and the second moving member 30 to enable the first installing member 21 and the second installing member 31 to be located in the installation state and stay there. Specifically, the driving assembly is a biasing member 61 for acting on the first moving member 20 and the second moving member 30 so that the first installing member 21 and the second installing member 31 are located in a preset state. In this embodiment, the biasing member 61 is a spiral spring which is out of the initial state under a certain external force and can restore to the initial state when the force is eliminated. The side of the second moving member 30 away from the first moving member 20 is provided with an opening groove 62 which is communicated with the second threaded hole of the second moving member 30. The threaded rod 41 protrudes out from the opening groove 62 and the spiral spring is sleeved on the portion of the threaded rod 41 protruding out from the opening groove 62. An inner diameter of the opening groove 62 is greater than that of the second threaded hole so that a step structure is formed at the connection between the opening groove 62 and the second threaded hole, and therefore one end of the spiral spring abuts against the groove bottom of the opening groove 62 and the other end abuts against a stopping structure 63 formed or provided by the threaded rod 41. The stopping structure 63 may be a projection extended form the threaded rod 41 or a gasket sleeved on the threaded rod 41. Thus, the biasing member 61 forces the first moving member 20 and the second moving member 30 to move to enable the first installing member 21 and the second installing member 31 to be located in the installation state. And, when the first installing member 21 and the second installing member 31 are located in the installation state, the spiral spring is in a compressed state so that a friction is generated between the second moving member 30 and the threaded rod 41, and therefore the second installing member 31 does not move. That is to say, the first installing member 21 and the second installing member 31 are located and kept in the installation state without any displacement, thereby better achieving one handed operation.

The first moving member 20 and the first installing member 21 are formed in one piece, and the second moving member 30 and the second installing member 31 are formed in one piece. The first moving member 20 and the first installing member 21 may also be arranged separately and connected together by a mechanical connection, and the second moving member 30 and the second installing member 31 may also be arranged separately and connected together by the mechanical connection.

The accessory device 100 of the present disclosure may be assembled as follows: firstly, the stopping structure 63 and the spiral spring are successively arranged on the threaded rod 41; secondly, the second moving member 30 is screwed to the threaded rod 41 through the second threaded hole; thirdly, the first moving member 20 is screwed to the threaded hole 41 through the first threaded hole; fourthly, the guide pin 51 is inserted into the guide hole 52 of the first moving member 20, and one end of the guide pin 51 adjacent to the second moving member 30 protrudes out from the guide hole 52, and the other end of the guide pin 51 away from the second moving member 30 is sealed by a screw; lastly, the first moving member 20 is rotated continually so that the end of the guide pin 51 protruding out from the guide hole 52 is inserted into the guide groove 53 of the second moving member 30. When the first moving member 20 and the first installing member 21 are arranged separately and the second moving member 30 and the second installing member 31 are arranged separately, the assembly method of the accessory device 100 further comprises the step of installing the first installing member 21 on the first moving member 20 and installing the second installing member 31 on the second moving member 30. Thus, the structure of the accessory device 100 of the present disclosure is simple and the assembly process thereof is also convenient.

During use, firstly, the first installing member 21 and the second installing member 31 are located in a non-installation state; secondly, the threaded rod 41 is rotated in a positive direction to force the second moving member 30 and the first moving member 20 to move towards each other, and to drive the first installing member 21 and the second installing member 31 to be located in the installation state; finally, after the use, the threaded rod 41 is rotated in an opposite direction to force the first moving member 20 and the second moving member 30 to move away from each other, and to drive the first installing member 21 and the second installing member 31 to go out of the installation state. In the present disclosure, the connecting assembly 40 forces the first installing member 21 and the second installing member 31 to be in or out of the installation state, thus the accessory device 100 may be disassembled easily in the use process and connected tightly and firmly. Additionally, since the threaded rod 41 has two sections of external threads with opposite revolving directions, the first moving member 20 and the second moving member 30 may be moved simultaneously during the using process so that the first installing member 21 and the second installing member 31 are moved into or out of the installation state. Thus, the structure is simple, the use is convenient and one hand operation is obtained. Moreover, when the second installing member 31 is to be positioned in an installing structure 210 of a main body 200, a friction is generated between the threaded rod 41 and the second moving member 30, thereby the second installing member 31 on the second moving member 30 may be steadily positioned in the installing structure 210 without any displacement, achieving one hand operation better.

Referring to FIG. 1, in the present embodiment, the functioning member 10 of the accessory device 100 is a laser transmitter connected to the first moving member 20 or the second moving member 30, and thus the accessory device 100 may serve as a laser transmitting device. The laser transmitter has a laser transmitting source 101 and a transmitting button 102. Meanwhile, in order to operate the connecting assembly 40 more conveniently and simply, the connecting assembly 40 of the accessory device 100 is also connected with a rotating button 103 for operating the connecting assembly 40.

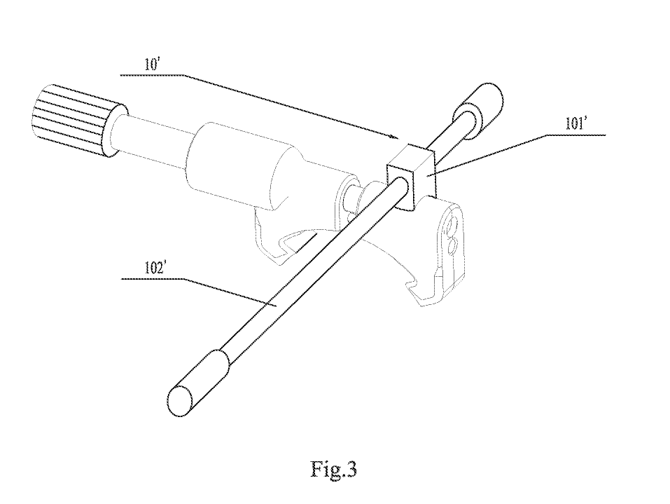

Referring to FIG. 3, it is may be appreciated by the person skilled in the art that the accessory device 100 can not only serve as a laser transmitting device, but also serve as other operating accessories, such as a positioning device. The accessory device 100 serves as a positioning device which has substantially the same structure as the laser transmitting device. The difference only lies in that a functioning member 10′ is a positioner comprising a fixing member 101′ and a positioning rod 102′.

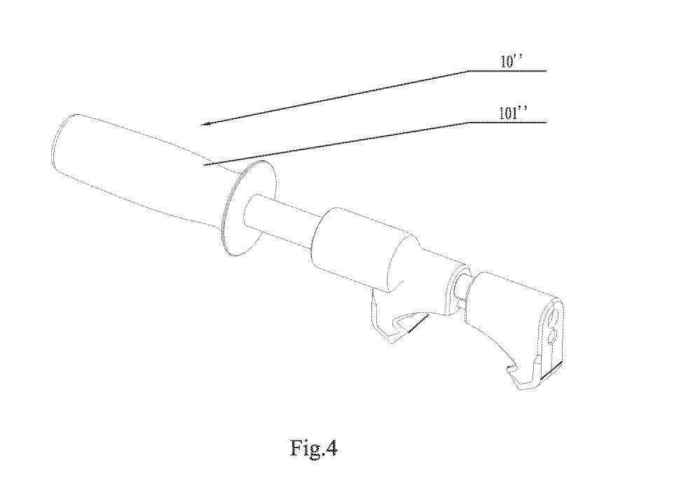

Referring to FIG. 4, it may be appreciated that the accessory device 100 of the present disclosure may also serve as a handle. A functioning member 10″ may be a gripping member 101″. Meanwhile, in order to make the structure of the accessory device 100 more simple, the gripping member 101″ also serves as a rotating button.

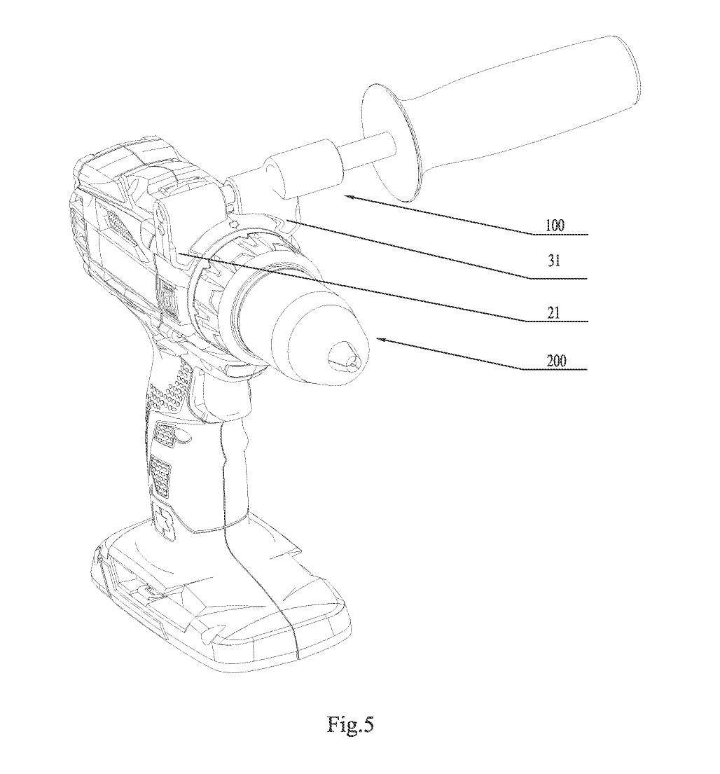

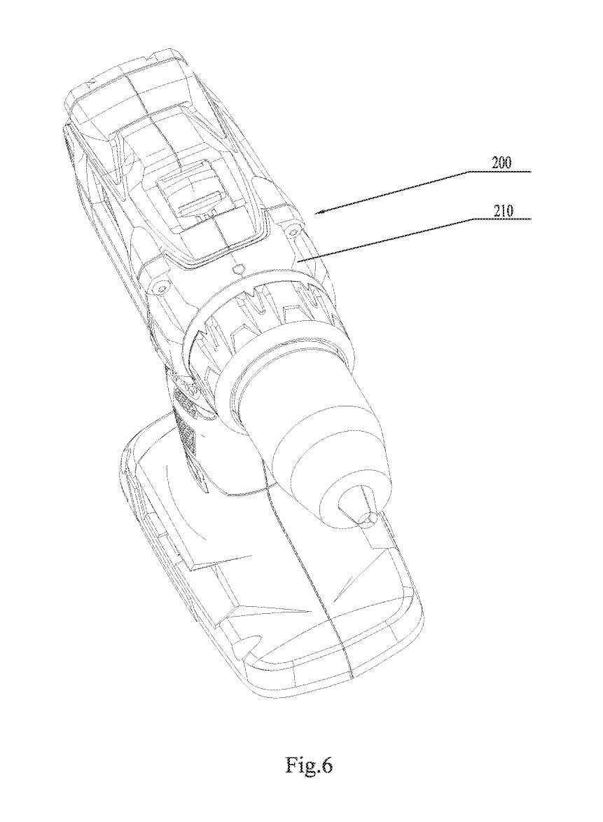

Referring to FIGS. 5 and 6, the present disclosure further provides a power tool. The power tool comprises the accessory device 100 and a main body 200. The main body 200 is provided with the installing structure 210 for cooperating with the first installing member 21 and the second installing member 31. In this embodiment, the main body 200 comprises a housing, and the installing structure 210 is a slot formed in the housing. The first installing member 21 and the second installing member 31 may be jaws which can be embedded into the slot.

The above illustrates and describes basic principles, main features, embodiments, and advantages of the subject device. Those skilled in the art should appreciate that the described embodiments are not intended to limit the scope of the invention claimed. Rather, technical solutions obtained in a way of equivalent substitution or equivalent variations shall fall within the scope of the invention claimed.

What is claimed is:

1. An accessory device for a power tool, comprising:
a first moving member;
a second moving member;
a functioning member associated with at least one of the first moving member and the second moving member; and
a connecting assembly for connecting the first moving member and the second moving member;
wherein the first moving member is provided with a first installing member and the second moving member is provided with a second installing member;
wherein the first installing member and the second installing member are located in an installation state when the first moving member and the second moving member are moved towards each other to a preset position; and
wherein the connecting assembly forces the first moving member and the second moving member to move simultaneously in a straight direction so as to enable the first installing member and the second installing member to be moved into or out of the installation state.

2. The accessory device according to claim 1, further comprising a guide assembly for guiding a relative movement between the first moving member and the second moving member.

3. The accessory device according to claim 2, wherein the guide assembly comprises a guide pin with two ends respectively and slidably arranged in the first moving member and the second moving member.

4. The accessory device according to claim 1, further comprising a driving assembly for driving the first moving member and the second moving member to enable the first installing member and the second installing member to be located in the installation state.

5. The accessory device according to claim 4, wherein the driving assembly comprises a biasing member for acting on the first moving member and the second moving member to force the first installing member and the second installing member to be located in a preset state.

6. The accessory device according to claim 1, wherein the connecting assembly comprises a threaded rod connected to the first moving member and the second moving member respectively by two sections of external threads with opposite revolving directions.

7. The accessory device according to claim 2, wherein the connecting assembly comprises a threaded rod connected to the first moving member and the second moving member respectively by two sections of external threads with opposite revolving directions.

8. The accessory device according to claim 3, wherein the connecting assembly comprises a threaded rod connected to the first moving member and the second moving member respectively by two sections of external threads with opposite revolving directions.

9. The accessory device according to claim 4, wherein the connecting assembly comprises a threaded rod connected to the first moving member and the second moving member respectively by two sections of external threads with opposite revolving directions.

10. The accessory device according to claim 5, wherein the connecting assembly comprises a threaded rod connected to the first moving member and the second moving member respectively by two sections of external threads with opposite revolving directions.

11. The accessory device according to claim 2, further comprising a driving assembly for driving the first moving member and the second moving member to force the first installing member and the second installing member to be located in the installation state.

12. The accessory device according to claim 11, wherein the guide assembly comprises a guide pin with two ends respectively and slidably arranged in the first moving member and the second moving member, the first moving member is provided with a guide hole, the second moving member is provided with a guide groove, the two ends of the guide pin are arranged in the guide hole and the guide groove respectively, the connecting assembly comprises a threaded rod connected to the first moving member and the second moving member respectively by two sections of external threads with opposite revolving directions, the first moving member is provided with a first threaded hole, the second moving member is provided with a second threaded hole, the first threaded hole and the second threaded hole have internal threads with different revolving directions respectively, the threaded rod passes through the second threaded hole and extends into the first threaded hole, and the two sections of external threads of the threaded rod cooperates with the internal threads in the first threaded hole and the second threaded hole respectively.

13. The accessory device according to claim 12, wherein the driving assembly comprises a biasing member for acting on the first moving member and the second moving member to force the first installing member and the second installing member to be located in a preset state, the biasing member is a spiral spring, one side of the second moving member away from the first moving member is provided with an opening groove which is communicated with the second threaded hole, the threaded rod protrudes out from the opening groove, the spiral spring is sleeved on a portion of the threaded rod protruding out from the opening groove, one end of the spiral spring abuts against a groove bottom of the opening groove and the other end abuts against a stopping structure provided by the threaded rod.

14. A power tool, comprising:
a main body; and
an accessory device for the main body;
wherein the accessory device comprises:
a first moving member;
a second moving member;
a functioning member associated with at least one of the first moving member and the second moving member; and
a connecting assembly for connecting the first moving member and the second moving member;
wherein the first moving member is provided with a first installing member and the second moving member is provided with a second installing member;
wherein the first installing member and the second installing member are located in an installation state when the first moving member and the second moving member are moved towards each other to a preset position;
wherein the connecting assembly forces the first moving member and the second moving member to move simultaneously in a straight direction so as to enable the first installing member and the second installing member to be moved into or out of the installation state; and
wherein the main body is provided with an installing structure for cooperating with the first installing member and the second installing member.

15. The power tool according to claim 14, wherein the main body comprises a housing, the installing structure is a slot formed in the housing, and the first installing member and the second installing member are jaws capable of being embedded into the slot.

16. The power tool according to claim 14, wherein the connecting assembly comprises a threaded rod connected to the first moving member and the second moving member respectively by two sections of external threads with opposite revolving directions.

17. A handle for a power tool, comprising:
a first moving member;
a second moving member;
a gripping member associated with at least one of the first moving member and the second moving member; and
a connecting assembly for connecting the first moving member and the second moving member;
wherein the first moving member is provided with a first installing member and the second moving member is provided with a second installing member;
wherein the first installing member and the second installing member are located in an installation state when the first moving member and the second moving member are moved towards each other to a preset position; and
wherein the connecting assembly forces the first moving member and the second moving member to move simultaneously in a straight direction so as to enable the first installing member and the second installing member to be in or out of the installation state.

18. The handle according to claim 17, further comprising a guide assembly for guiding the relative movement between the first moving member and the second moving member and a driving assembly for driving the first moving member and the second moving member to force the first installing member and the second installing member to be located in the installation state.

19. The handle according to claim 17, wherein the connecting assembly comprises a threaded rod connected to the first moving member and the second moving member respectively by two sections of external threads with opposite revolving directions.

20. The handle according to claim 18, wherein the guide assembly comprises a guide pin with two ends respectively and slidably arranged in the first moving member and the second moving member, the first moving member is provided with a guide hole, the second moving member is provided with a guide groove, the two ends of the guide pin are arranged in the guide hole and the guide groove respectively, the connecting assembly comprises a threaded rod connected to the first moving member and the second moving member respectively by two sections of external threads with opposite revolving directions, the first moving member is provided with a first threaded hole, the second moving member is provided with a second threaded hole, the first threaded hole and the second threaded hole have internal threads with different revolving directions respectively, the threaded rod passes through the second threaded hole and extends into the first threaded hole, the two sections of external threads with opposite revolving directions of the threaded rod cooperates with the internal threads in the first threaded hole and the second threaded hole respectively, the driving assembly comprises a biasing member for acting on the first moving member and the second moving member to force the first installing member and the second installing member to be located in a preset state, the biasing member is a spiral spring, one side of the second moving member away from the first moving member is provided with an opening groove which is communicated with the second threaded hole, the threaded rod protrudes out from the opening groove, the spiral spring is sleeved on a portion of the threaded rod protruding out from the opening groove, one end of the spiral spring abuts against a groove bottom of the opening groove and the other end abuts against a stopping structure formed or provided by the threaded rod.
